(19) United States
(12) Patent Application Publication
(10) Pub. No.: US 2022/0331998 A1
(43) Pub. Date: Oct. 20, 2022

(54) ELECTRIC KNIFE

(71) Applicant: AOB Products Company, Columbia, MO (US)

(72) Inventors: Dennis W. Cauley, JR., Fayette, MO (US); James Tayon, Moberly, MO (US); Timothy S. Kinney, Warrenton, MO (US); Matthew Kinamore, Columbia, MO (US); Curtis Smith, Columbia, MO (US); Mark Dalton, Columbia, MO (US); Chris Lang, Columbia, MO (US)

(21) Appl. No.: 17/659,460

(22) Filed: Apr. 15, 2022

Related U.S. Application Data
(60) Provisional application No. 63/175,415, filed on Apr. 15, 2021.

(51) Int. Cl. B26B 7/00; B25F 5/00; B25F 5/02

(52) U.S. Cl. CPC B26B 7/00; B25F 5/008; B25F 5/02

(57) ABSTRACT

An electric hand tool (e.g., electric knife) and associated components and methods. The tool includes improved motor venting features and other features.

### CROSS-REFERENCE TO RELATED APPLICATION

The present application claims priority to U.S. Provisional Patent App. No. 63/175,415, filed Apr. 15, 2021, which is hereby incorporated by reference in its entirety.

### FIELD

The present disclosure generally relates to electric knives.

### BACKGROUND

An electric knife, specifically the motor of an electric knife, generates heat during its use. Overheating may be bad for the health of the motor. Overheating may reduce performance and life expectancy of an electric knife.

### SUMMARY

In one aspect, an electric knife comprises a handle and a motor in the handle. The motor includes a motor fan, a motor housing, and a motor housing vent. The motor fan is arranged to force air out of the motor housing through the motor housing vent. The motor housing vent has a first vent flow area. The handle comprises a handle vent arranged to permit flow of air out of the handle from the motor housing vent. The handle vent has a second flow area greater than the motor housing vent.

In another aspect, an electric knife comprises a handle and a motor in the handle. The motor includes a motor fan, a motor housing, and a motor housing vent. The motor fan is arranged to force air tangentially with respect to the fan out of the motor housing vent. The handle comprises a handle vent arranged to permit direct flow of air out of the handle from the motor housing vent. The handle vent is arranged to receive direct flow of air tangentially from the fan.

In yet another aspect, an electric tool comprises a handle body and a cover on the handle body. The cover includes a cover body and at least one tab extending from the cover body. The tab is captured by the handle body to retain the cover on the handle body.

Other objects and features of the present disclosure will be in part apparent and in part pointed out herein.

### BRIEF DESCRIPTION OF THE DRAWINGS

FIG. 1 is a left side view of an electric knife;

FIG. 2 is a left side view of a pair of blades of the electric knife;

FIG. 3 is a top perspective of a battery of the electric knife;

FIG. 4 is a left side view of a handle of the knife with the battery;

FIG. 5 is a view similar to FIG. 4 but omitting the battery;

FIG. 6 is a view of left and right housing portions of the handle disassembled from each other;

FIG. 7 is an exploded perspective of the left housing portion;

FIG. 8 is a view similar to FIG. 7 but showing a screen of the left housing portion installed on a body of the left housing portion;

FIG. 9 is an enlarged elevation of the screen;

FIG. 10 is a left elevation of the right housing portion;

FIG. 11 is a fragmentary exploded right perspective of the right housing portion;

FIG. 12 is an enlarged fragmentary left perspective of the right housing portion;

FIG. 13 is an enlarged fragmentary right elevation of the right housing portion;

FIG. 14 is an enlarged perspective of a vent cover of the right housing portion;

FIG. 15 is a bottom view of the handle showing the left and right handle housing portions partially separated from each other;

FIG. 16 is a top view of the handle;

FIG. 17 is a perspective of a motor assembly and drive train of the electric knife;

FIG. 18 is a right elevation of the motor assembly and drive train in the left handle housing;

FIG. 19 is a rear view of a motor fan;

FIG. 20 is a rear view of the motor assembly; and

FIG. 21 is a right elevation of a second embodiment of an electric knife of the present disclosure.

Corresponding reference numbers indicate corresponding parts throughout the drawings.

### DETAILED DESCRIPTION

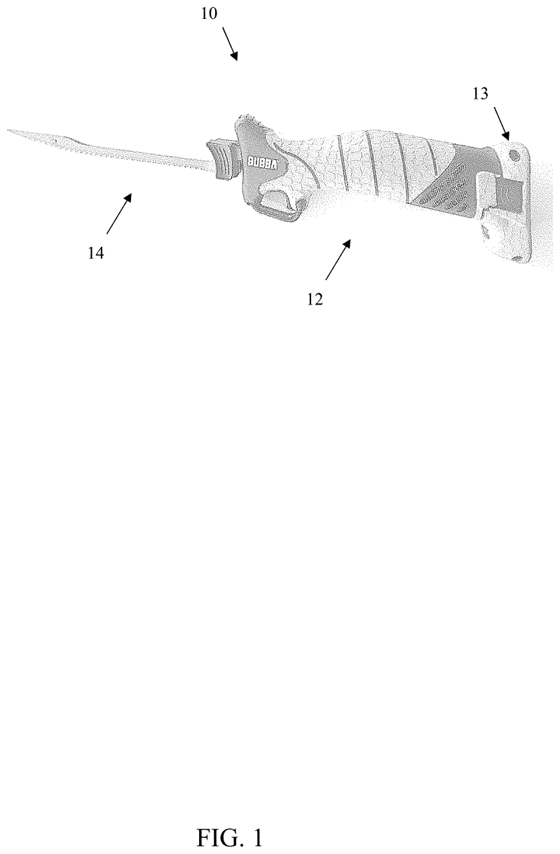

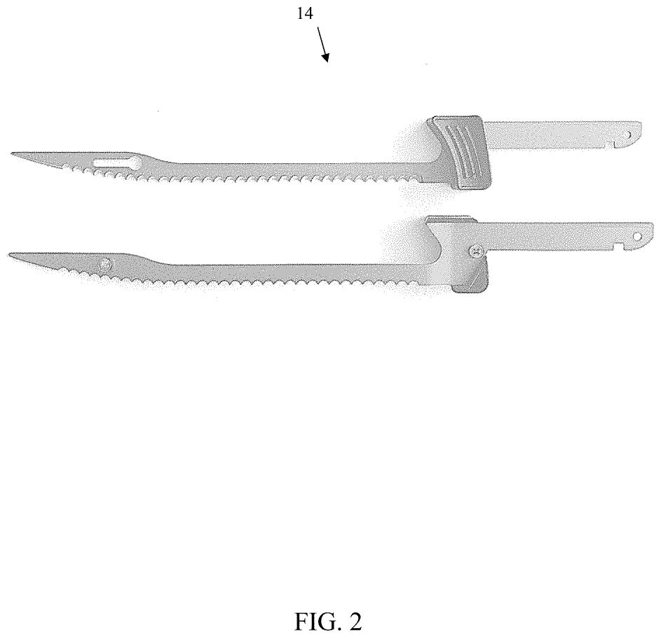

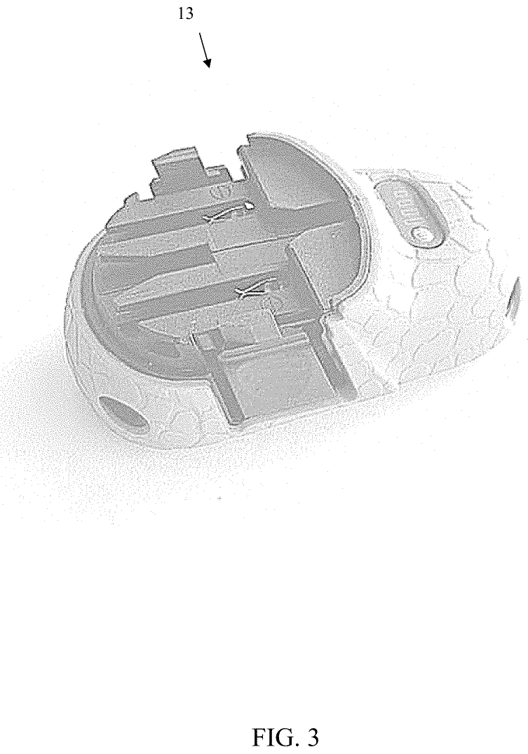

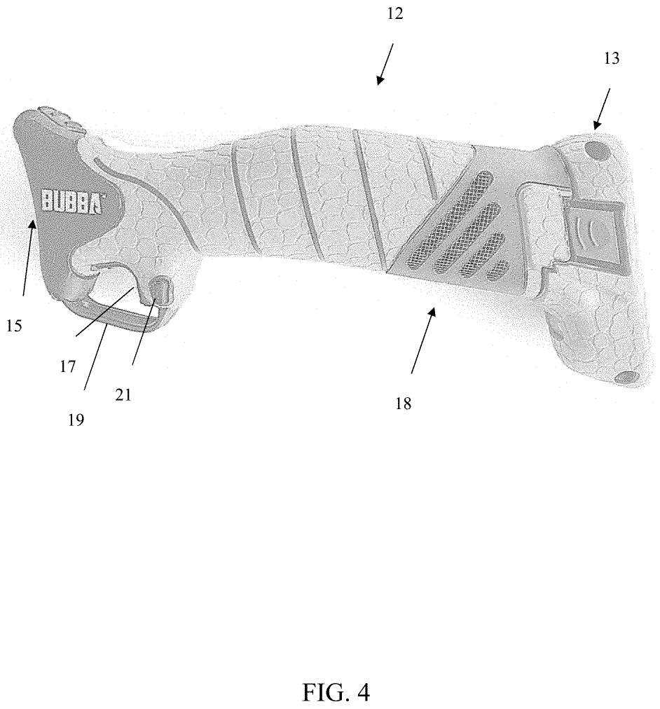

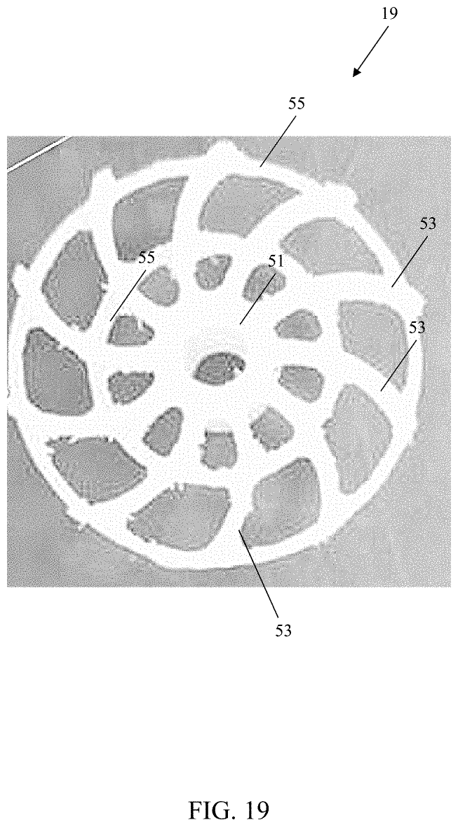

Referring to FIGS. 1-4 and 17-19, an electric knife 10 can be used, for example, to cut or fillet fish. The electric knife includes a handle 12 and a blade assembly 14 including a pair of blades. The handle 12 is sized and shaped to be held by a hand of a user. The handle 12 defines an interior for housing a motor assembly 16 that oscillates the blades of the blade assembly 14. The motor assembly comprises a motor housing 16A, a motor housing body 16B, motor housing vents 16L, 16R, and a motor fan 19. The motor is powered by a battery 13.

In the illustrated embodiment, the blade assembly 14 includes two blades useable together with the handle. The blades move relative to each other in a reciprocating movement. Other configurations of blades (e.g., one blade) can be used without departing from the scope of the present disclosure.

The handle 12 includes a blade receiver 15, a trigger 17, a trigger guard 19, and a safety lock 21. The handle 12 includes a battery connector 23 opposite the blade receiver 15 for forming a mounting connection and electrical connection with the battery. The handle 12 includes a grip between the trigger 17 and the battery 13 constructed to be grasped by a hand of the user. As explained in further detail below, the handle 12 includes opposing left and right handle vents 18 to facilitate venting of the handle interior and egress of heat from the motor.

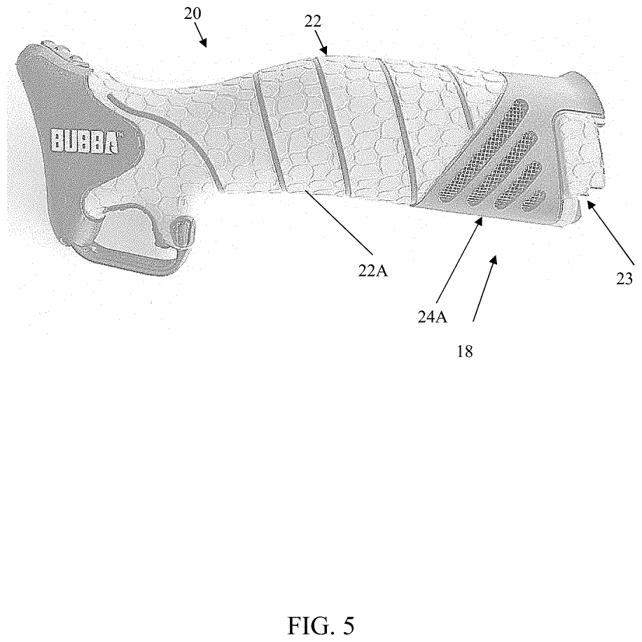

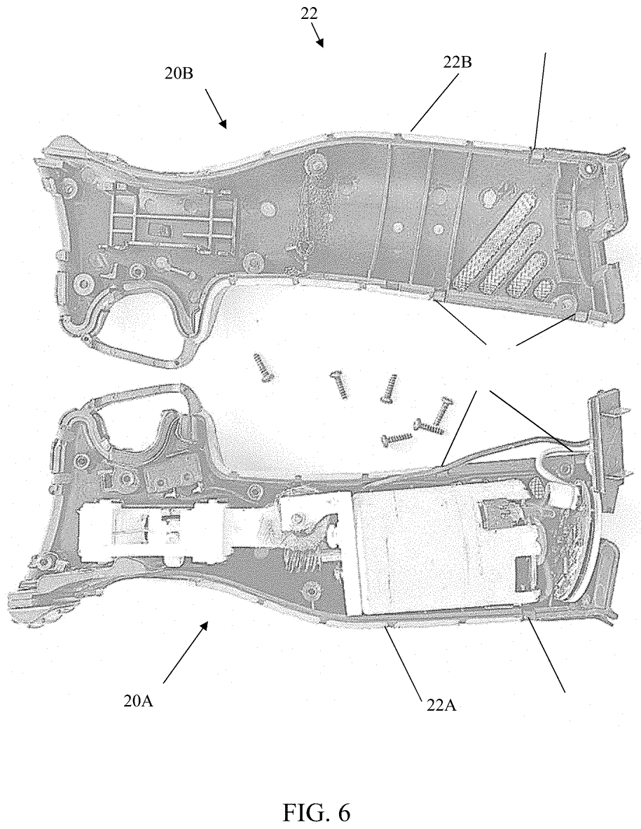

As shown in FIGS. 5-6, the handle defines a housing comprising a housing body 22. In the illustrated embodiment, the housing comprises a left (first) housing portion 20A and a right (second) housing portion 20B. The left and right housing portions 20A, 20B define holes for receiving fasteners (e.g. screws) for fastening the first and second housing portions together. Each housing portion 20A, 20B includes a housing body portion 22A, 22B that can be formed by injection molded plastic or other suitable material. In the illustrated embodiment, the plastic is overmolded with a polymeric material (e.g., Kraton) to provide a high friction and nonslip outer gripping surface. The left and right housing body portions 22A, 22B collectively form the housing body 22.

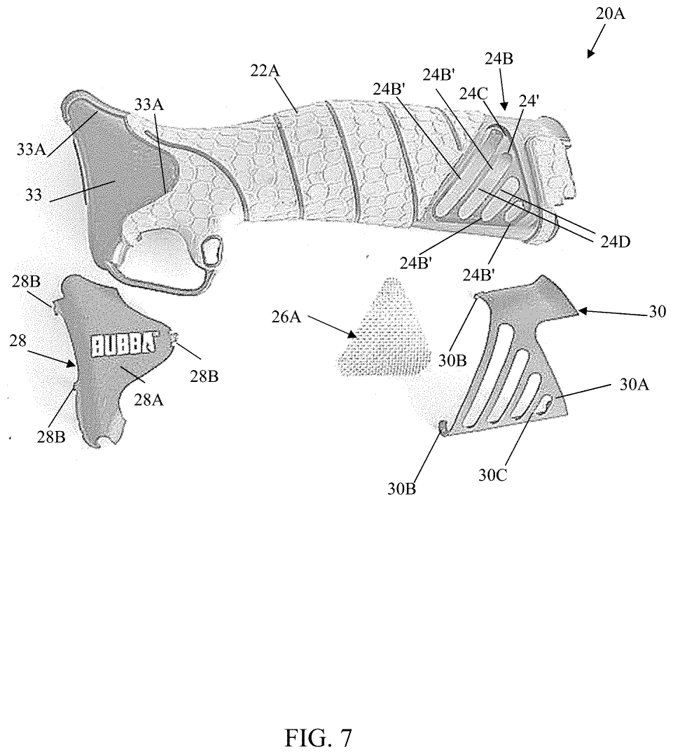

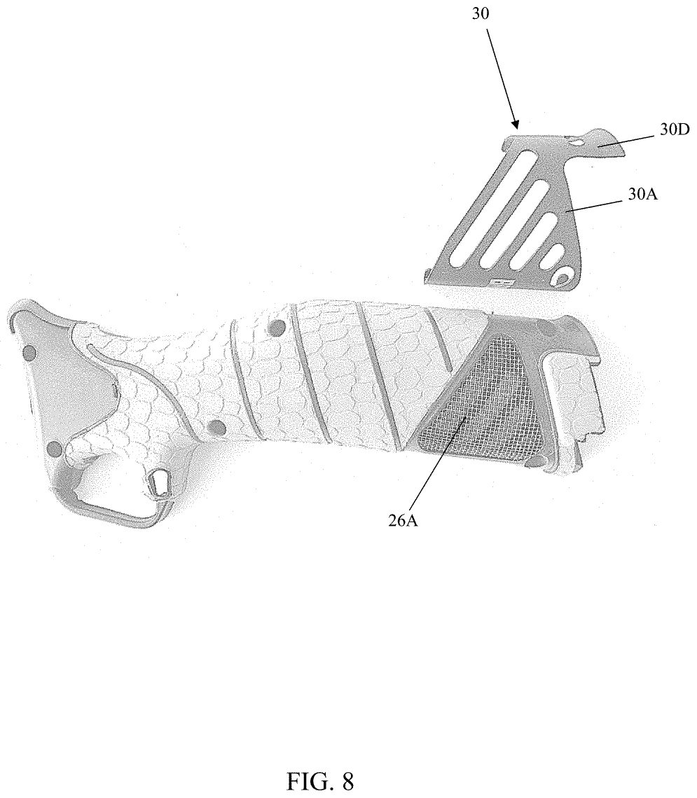

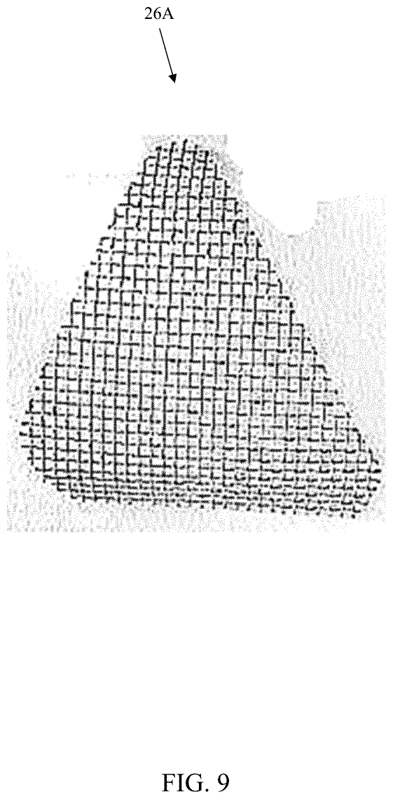

The left housing portion 20A will be described in more detail with reference to FIGS. 7-9. The left housing portion 20A includes the left housing body portion 22B, a screen (broadly, “web”) 26A, and a vent cover 30. A rear segment of the housing body portion 22B, the screen 26A, and the vent cover 30 form a left housing vent assembly 24A (FIG. 5) defining the left vent 18. The rear segment of the left housing body portion 22A defines a left housing body vent 24B. In the illustrated embodiment, this rear segment of the left housing body portion is not overmolded with polymeric material, and the left handle body vent 24B is generally triangular. The left handle body vent 24B includes four vent openings 24B′. Each vent opening has a respective vent flow area, and the sum of the vent flow areas of the vent openings 24B′ defines the vent flow area of the left handle body vent 24B. The left handle body vent 24B is provided in a generally triangular recess in the left housing body portion to form a shoulder 24C around the periphery of the left handle body vent. The shoulder 24C extends around a bed 24′ sized and shaped to receive the screen. The left housing body portion 22A defines a plurality of ribs 24D that extend between and define sides of the vent openings 24B′. In the illustrated embodiment, there are four vent openings 24B′ arranged in a row with respect to each other and which progressively increase in vent flow area. In other embodiments, the pattern, size, shape, and/or number of the openings may vary without departing from the scope of this disclosure.

The screen 26A is sized and shaped to overlie the left handle body vent 24B and to fit on the bed 24′ within the peripheral shoulder 24C. The screen 26A can be formed of a woven or non-woven mesh (e.g., metal mesh) and defines a plurality of openings smaller than the vent openings 24B′. The screen 26A acts as a safety feature to obstruct ingress of fingers, debris, etc. into the housing.

The left vent cover 30 is configured to connect to the rear segment of the left housing body portion 22A and to overlie the screen 26A to capture the screen and maintain the position of the screen on the bed 24′. The vent cover 30 can be formed of aluminum or another suitable material. The vent cover 30 comprises a vent cover body 30A having an exterior surface and having an interior surface that opposes the corresponding rear segment of the left housing body portion 22A. The vent cover body 30A defines a plurality of vent openings spaced apart by ribs 30C that extend between and define sides of the openings. In the illustrated embodiment, there are four openings that correspond in size, shape, and arrangement to the vent openings 24B′ of the housing body portion 22A. The vent openings of the vent cover 30 are arranged to be in registration with the vent openings 24B′ of the handle body vent 24B to facilitate evacuation of hot air from the motor assembly. Other patterns, sizes, shapes, and numbers of openings can be used without departing from the scope of this disclosure.

Tabs 30B extending from the periphery of the vent cover body 30A are provided for connecting the vent cover 30 to the housing body portion 22A. The rear segment of the left housing body portion 22A defines openings in its periphery for receiving the tabs 30B. To assemble the left housing vent assembly 24A, the screen 26A is disposed on the bed 24′, and the cover 30 is installed over the screen. The cover 30 is retained in position by folding the tabs 30B relative to the cover body 30A to locate the tabs in the openings of the housing body portion 22B. When the cover 30 is installed, peripheral edges of the cover body 30A are located near shoulders of the housing body portion 22B to provide a smooth transition from the exterior surface of the overmolding of the housing body portion to the exterior surface of the cover body. For example, the exterior surface of the cover body 30A can be generally flush with the exterior surface of the overmolding. This provides the housing portion 20A with an aesthetically pleasing appearance and integrates the components for a desirable composite construction.

The arrangement is such that segments of the screen 26A overlie (are in registration with) the vent openings 24B′ of the handle body vent 24B and underlie (are in registration with) the vent openings of the cover 30. The total vent flow area of the left housing vent assembly 24A (i.e., the left vent 18) is the sum of the flow areas of the openings in the portions of the screen 26A that are in registration with the vent openings of the handle body portion 22A and the cover 30.

Other configurations of vents or vent assemblies can be used without departing from the scope of the present disclosure. For example, the screen may be provided on the inside of the housing body portion and/or the cover may be omitted. The screen may be secured in position to extend across the vent openings by suitable forms of fastening, molding, adhering, etc.

Referring to FIG. 7, the left housing portion includes a forward cover 28 configured to overlie a forward segment of the housing body portion 22A. The forward cover 28 can be made of aluminum or another suitable material. The forward segment of the housing body portion 22A defines a bed 33 on which the cover is receivable. The bed 33 is not overmolded. Shoulders 33A of the housing body portion 22A extend around the bed 33. The cover includes a cover body 28A having an exterior surface and having an interior surface that opposes the bed. The cover includes tabs 28B extending from a periphery of the cover body. The forward segment of the housing body portion 22A defines openings for receiving the tabs. To install the cover 28, the cover body 28A is located on the bed 33, and the tabs 28BA are folded over to secure the cover to the housing body portion 22B. When the cover 28 is installed, peripheral edges of the cover body 28A are located near the shoulders 33A of the housing body portion 22A to provide a smooth transition from the exterior surface of the overmolding of the housing body portion to the exterior surface of the cover body. For example, the exterior surface of the cover body 28A can be generally flush with the exterior surface of the overmolding. This provides the housing portion 20A with an aesthetically pleasing appearance and integrates the components for a desirable composite construction.

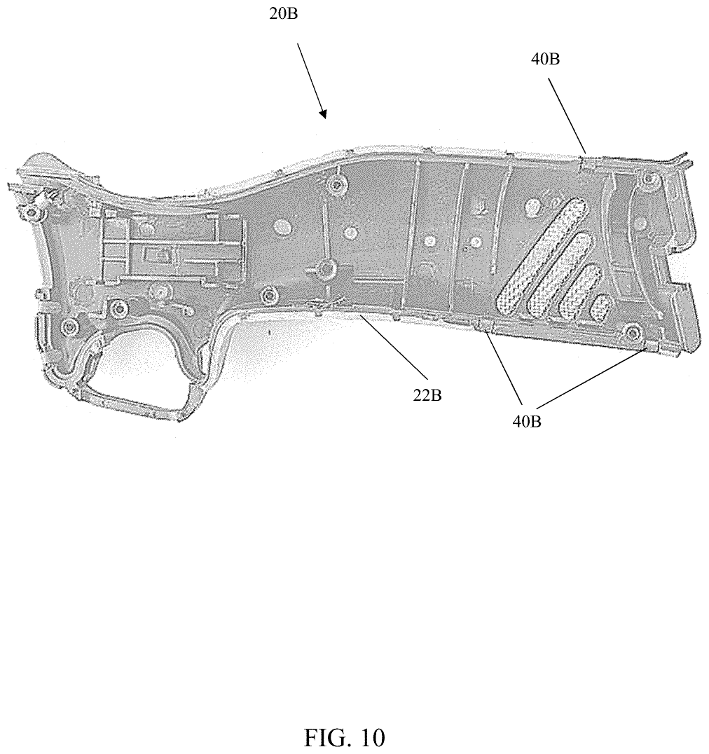

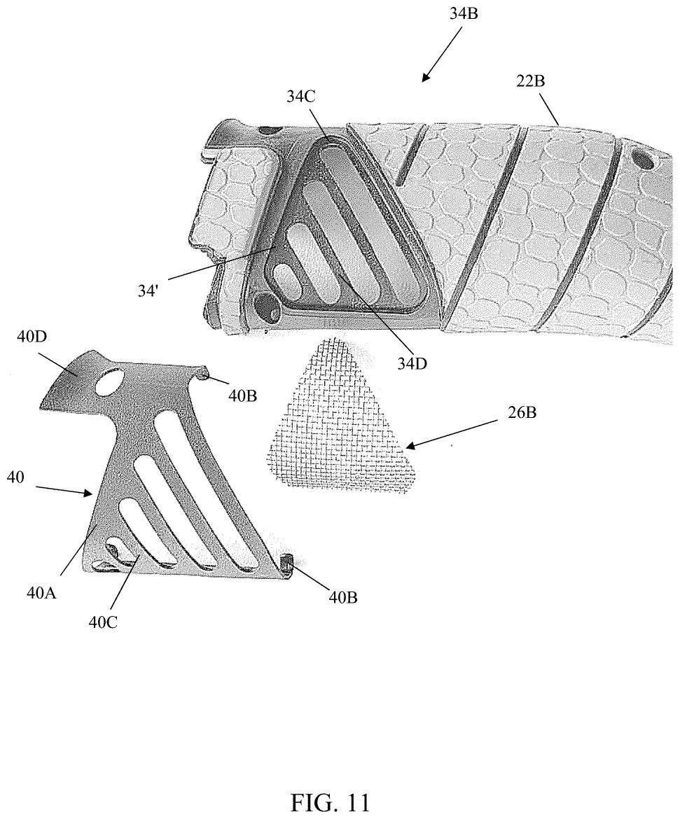

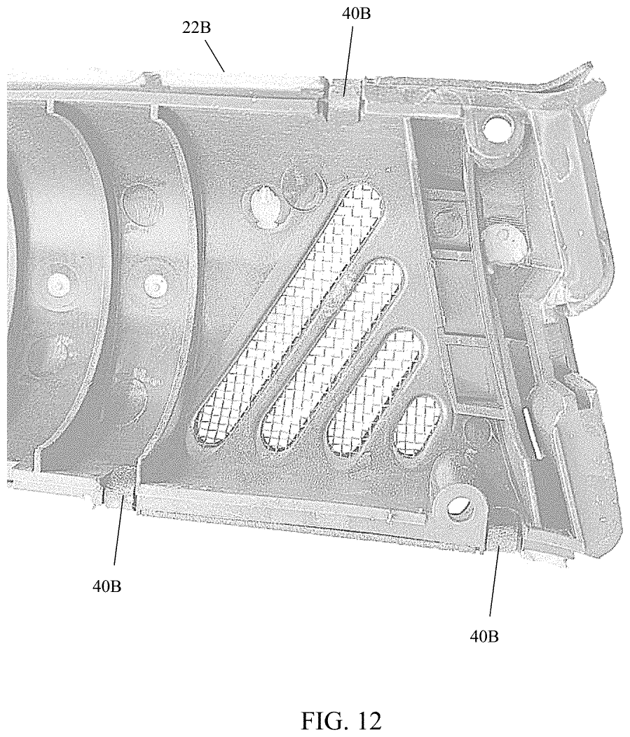

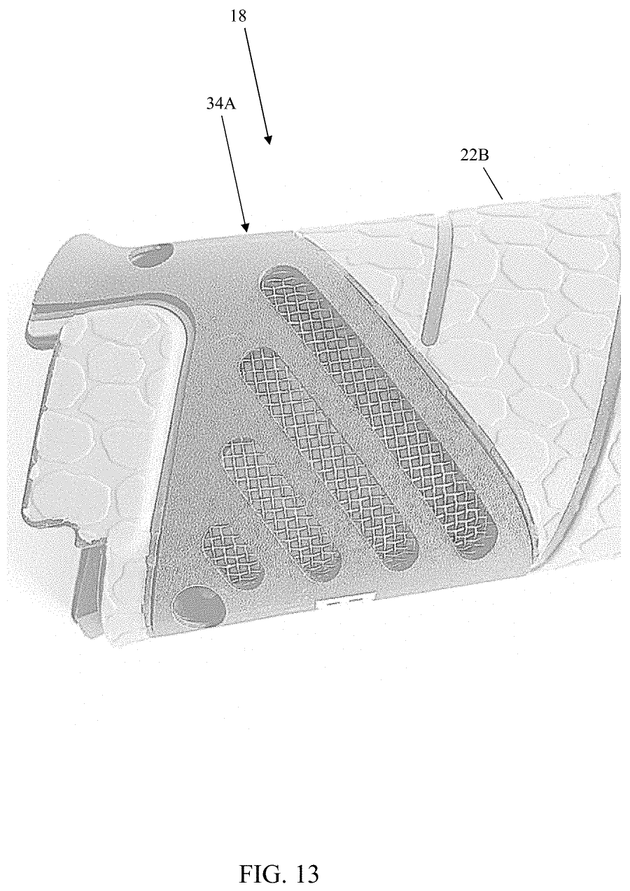

Referring now to FIGS. 10-14, it will be understood that the right housing portion 20B is substantially identical to (but a mirror image of) the left housing portion 20A. For example, the right housing portion 20B includes a right housing body portion 22B, a screen 26B (broadly, “web”), and a vent cover 40. A rear segment of the housing body portion 22B, the screen 26B, and the vent cover 40 form a right housing vent assembly 34A, defining the right vent 18, having a substantially identical construction as described above with respect to the left housing portion 20A.

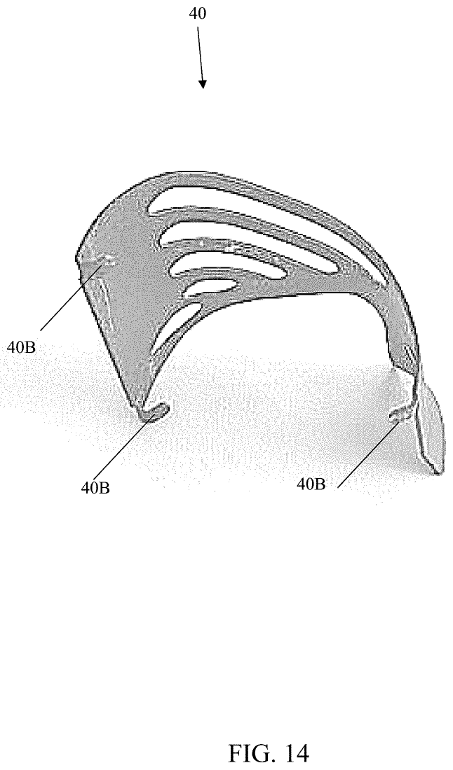

Referring to FIG. 14, the cover 40 has a substantially identical but mirror image construction as the forward cover 28 of the left housing portion 20A. The cover 40 includes a cover body and tabs 40B. The cover 40 is installed in essentially the same way as described above with respect to the left housing portion 20A.

The right housing portion 20B also includes a forward cover 43 having a substantially identical but mirror image construction as the forward cover 28. The cover 43 has tabs and is installed on the right housing body portion 22B in essentially the same manner as the cover 28.

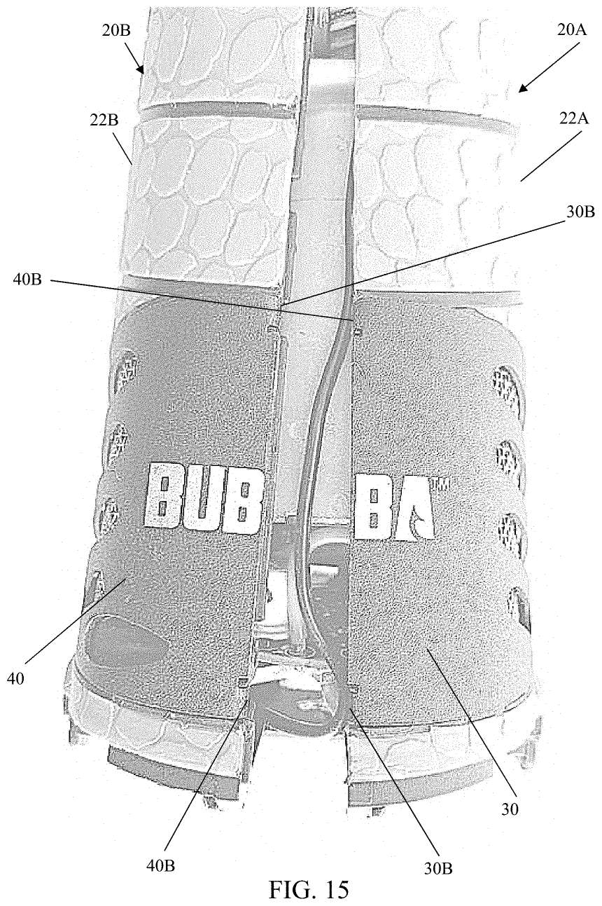

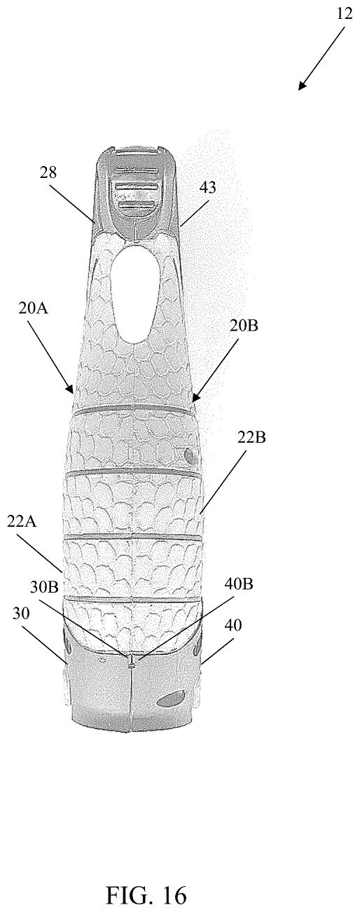

The left and right housing portions 20A, 20B are configured to be connected together such as by screws. When the housing portions are connected to each other, the edge margins of the left and right housing portions 20A, 20B contact each other, thereby forcing the tabs 30B, 40B, 28B to be captured between the edge margins of the housing body portions. For example, as will be appreciated with reference to FIGS. 15 and 16, the tabs 30B, 40B of the corresponding covers 30, 40 of the left and right housing portions may abut each other. Such capturing of the tabs resists the tabs from unfolding and thus secures the covers in position. Inadvertent removal of the covers is substantially prohibited unless the housing portions 20A, 20B are disassembled from each other to permit unfolding of the tabs.

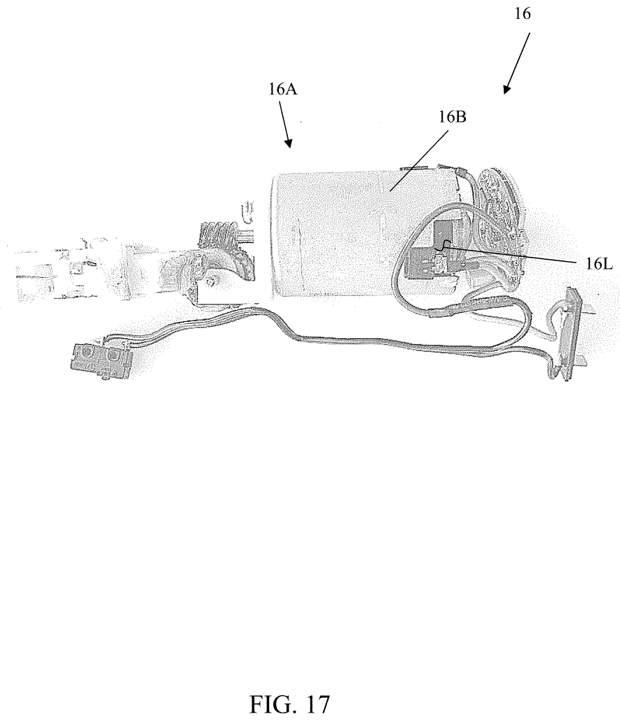

Referring now to FIGS. 17-20, the motor assembly 16 is configured to be housed within the left housing portion 20A and the right housing portion 20B when they are connected together to form the handle 12 The motor can be a brushless motor offering at least 25%-30% efficiency over a brushed motor, but brushed motors or other motors could be used.

The motor fan 19 comprises a hub 51 and curved blades 53 extending from the hub. The blades 53 are connected to each other by annular blade supports 55. The blade supports help maintain the positions of the blades 53 with respect to each other and help the blades maintain their shape. Desirably, each blade includes a blade body that is arcuate in shape. The fan 19 can be arranged to rotate in the direction of the curve of the arcuate fan blades (e.g., clockwise as viewed from the rear). However, the fan wheel may rotate in the opposite direction.

The motor housing 16A defines a motor housing body 16B. The motor housing body is generally cylindrical, having a forward end and an opposite rear end. The motor includes a motor shaft on which the fan 19 is mounted and which rotates the fan about an axis of rotation AR, which is the longitudinal axis of the motor shaft. The fan 19 is mounted in the rear end of the motor housing 16A.

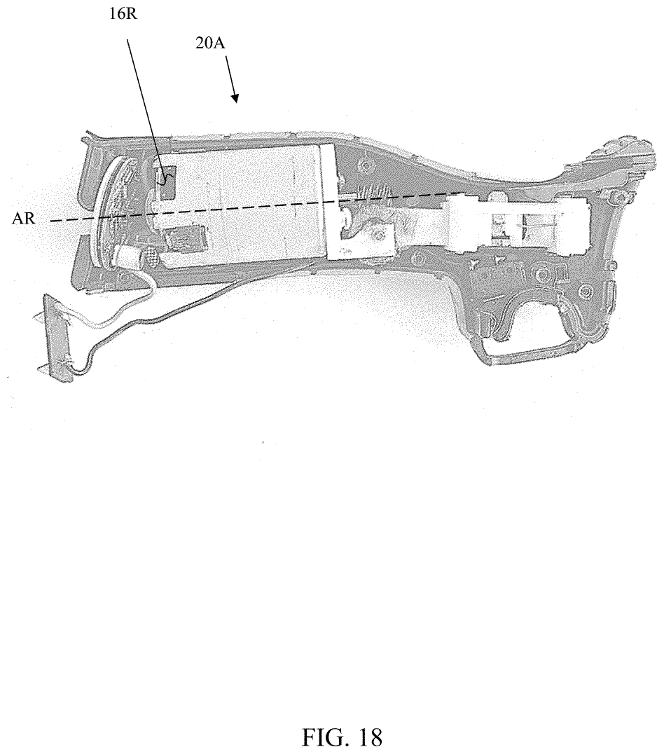

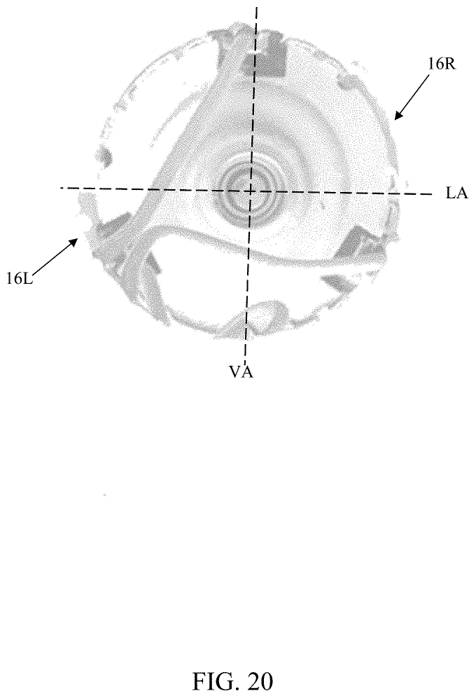

The motor housing body 16B defines motor housing vents 16L, 16R (left, right) arranged to facilitate expulsion of heat created by the motor assembly. The left motor housing vent 16L as viewed in FIG. 17 is partially obstructed by an electrical connector overlying the left motor housing vent. The blades 53 rotate in a plane generally perpendicular to the axis of rotation AR and the motor housing vents 16L, 16R, (broadly, “openings”) are intersected by that plane such that the blades are arranged to force air off the ends of the blades through the motor housing vents. The fan 19 is configured to expel air substantially tangentially from the fan. The motor housing vents 16L, 16R are arranged to facilitate this tangential flow of air from the fan 19 to the left and right handle vents 18. The motor housing vents 16L, 16R are provided on opposing left and right sides of the motor housing 16B, but the center of the left motor housing vent is lower than the center of the right motor housing vent. The centers of the motor housing vents 16L, 16R are located between the upper and lower ends of the respective vents. As will be understood by reference to FIGS. 17 and 20, the center of the left motor housing vent 16L is located below a horizontal plane LA intersecting the axis of rotation AR. As will be understood by reference to FIGS. 18 and 20, a center of the right motor housing vent 16R is located above the plane LA. The motor housing vents 16L, 16R are not intersected by a vertical plane VA passing through the axis of rotation. The arrangement is such that air being expelled tangentially from the left motor housing vent 16L is directed generally upwardly and toward a center of the left handle vent 18, and air being expelled tangentially from the right motor housing vent 16R is directed generally downward and toward a center of the right handle vent 18. The left motor housing vent 16L is in lateral registration with an upper portion of the left handle vent 18, and the right motor housing vent 16R is in lateral registration with a lower portion of the right handle vent 18. The arrangement of the fan 19, motor housing vents 16L, 16R, and handle vents 18 is optimized to promote direct tangential flow of air from the fan 19 out of the handle vents (rather than being trapped in the handle) to promote cooling and improved performance of the motor.

Desirably, the vent flow area of each handle vent 18 is greater than the venting area of the respective motor housing vent 16L, 16R. This reduces air flow restriction and facilitates movement of hot air away from the motor and out of the handle housing. The venting assembly allows for at least 40%-50% increased cooling efficiency. For example, the vent flow area of the handle vent 18 can be at least 20% greater than the vent flow area of the corresponding motor housing vent 16L, 16R (more desirably, at least 50% greater, more desirably at least 75% greater, more desirably at least 100% greater, more desirably at least 150% greater, more desirably at least 200% greater, more desirably at least 250% greater, more desirably at least 300% greater). Other configurations can be used without departing form the scope of the present disclosure.

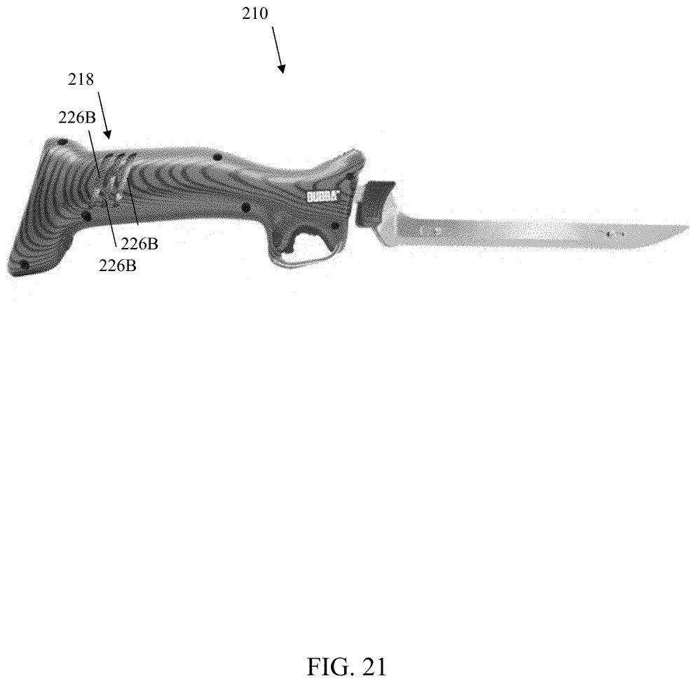

FIG. 21 shows a second embodiment of an electric knife 210 of the present disclosure. The knife 210 is substantially similar to the knife 10 described above, and like components are indicated by like reference numbers, plus 200. In this embodiment, the handle has handle portions (the right handle portion 220B being shown) lacking the forward and rear covers 43, 40 included in the first embodiment. Left and right vents 218 are provided in the housing portions to facilitate egress of air from the internal fan. The vent assembly includes a screen 226B as in the prior embodiment, but the screen is provided on the inside of the housing body rather than between the housing body and a cover. The arrangement and operation of the motor, fan, and motor housing vents can be essentially the same as explained above with respect to the first embodiment.

It will be apparent that modifications and variations are possible without departing from the scope of the invention defined in the appended claims. The dimensions and proportions described herein are by way of example without limitation. Other dimensions and proportions can be used without departing from the scope of the present disclosure.

As various changes could be made in the above constructions and methods without departing from the scope of the invention, it is intended that all matter contained in the above description and shown in the accompanying drawings shall be interpreted as illustrative and not in a limiting sense.

What is claimed is:

1. An electric knife comprising:
a handle;
a motor in the handle, the motor including a motor fan, a motor housing, and a motor housing vent, the motor fan arranged to force air out of the motor housing through the motor housing vent, the motor housing vent having a first vent flow area; and
wherein the handle comprises a handle vent arranged to permit flow of air out of the handle from the motor housing vent, the handle vent having a second flow area greater than the motor housing vent.

2. An electric knife comprising:
a handle;
a motor in the handle, the motor including a motor fan, a motor housing, and a motor housing vent, the motor fan arranged to force air tangentially with respect to the fan out of the motor housing vent; and
wherein the handle comprises a handle vent arranged to permit direct flow of air out of the handle from the motor housing vent, the handle vent being arranged to receive direct flow of air tangentially from the fan.

3. An electric tool comprising:
a handle body; and
a cover on the handle body, the cover including a cover body and at least one tab extending from the cover body, the tab being captured by the handle body to retain the cover on the handle body.
